(19) United States
(12) Patent Application Publication
(10) Pub. No.: US 2021/0316526 A1
(43) Pub. Date: Oct. 14, 2021

(54) FIBER-REINFORCED COMPOSITE BLANK, FIBER-REINFORCED COMPOSITE COMPONENT, ROTOR BLADE ELEMENT, ROTOR BLADE AND WIND TURBINE AND METHOD FOR PRODUCING A FIBER-REINFORCED COMPOSITE BLANK AND METHOD FOR PRODUCING A FIBER-REINFORCED COMPOSITE COMPONENT

(71) Applicant: Wobben Properties GmbH, Aurich (DE)

(72) Inventors: Alexander HOFFMANN, Emden (DE); Sara NGANGA, Aurich (DE)

(21) Appl. No.: 17/271,973

(22) PCT Filed: Aug. 9, 2019
(86) PCT No.: PCT/EP2019/071503

§ 371 Date: Feb. 26, 2021

(30) Foreign Application Priority Data
Aug. 27, 2018 (DE) 10 2018 120 905.3

(51) Int. Cl. B32B 3/08; B29C 70/08; B29C 70/30; B32B 5/24; B32B 21/10; B32B 27/12; B32B 27/30; B32B 27/32; F03D 1/06; F03D 13/20

(52) U.S. Cl. CPC B32B 3/08; B29C 70/086; B29C 70/088; B29C 70/30; B32B 5/245; B29L 2031/085; B32B 27/12; B32B 27/304; B32B 27/32; F03D 1/0675; F03D 13/20; B32B 21/10

(57) ABSTRACT

A fiber-reinforced composite blank for a fiber-reinforced composite component, in particular for a fiber-reinforced composite component of a wind turbine, comprising a layered construction with a form core consisting of or comprising a form core material, and a fiber layer adjoining the form core, said fiber layer consisting of or comprising a fiber layer material, and a plurality of reinforcing rods introduced into the form core and consisting of or comprising a reinforcing material, wherein the reinforcing material has a higher stiffness than the form core material. In this arrangement, the plurality of reinforcing rods is introduced into the form core at an angle to a form core plane. Furthermore, at least one reinforcing rod of the plurality of reinforcing rods is introduced into the form core at an angle to a direction orthogonal to the form core plane.

### BACKGROUND

### Technical Field

The invention relates to a fiber-reinforced composite blank for a fiber-reinforced composite component, in particular for a fiber-reinforced composite component of a wind turbine, comprising a layered construction and a plurality of reinforcing rods, to a fiber-reinforced composite component comprising a fiber-reinforced composite blank and a matrix material, to a rotor blade element for a rotor blade, in particular for a wind turbine, to a rotor blade and to a wind turbine comprising a tower, a nacelle, and a rotor having a rotor hub and a plurality of rotor blades.

Furthermore, the invention relates to a method for producing the fiber-reinforced composite blank and to a method for producing the fiber-reinforced composite component.

### Description of the Related Art

Fiber-reinforced composite components are components comprising two or more components connected to one another, consisting of or comprising fiber-reinforced composite materials, which generally have functional properties. Fiber-reinforced composite materials comprise or consist substantially of fibers and a matrix in which the fibers are embedded. Owing to interactions that occur between the fibers and the matrix, fiber-reinforced composite materials have more valuable properties than either the fibers or the matrix per se.

Fiber-reinforced composite components, fiber-reinforced composite blanks for producing the fiber-reinforced composite components, and constituent parts of fiber-reinforced composite components or fiber-reinforced composite blanks in different embodiments and the production methods therefor are known in principle.

In DE 10 2013 215 384 A1, for example, a description is given of a composite molding and of a method for producing a composite molding, in particular for a wind turbine, comprising a thermoplastic resin and a fiber-reinforced composite blank, the method comprising the following steps: making available the thermoplastic resin and the fiber-reinforced composite blank with a flexible braid-like fiber system, distributing the thermoplastic resin as a shaping core material in the flexible braid-like fiber system of the fiber-reinforced composite blank, and bonding to the braid-like fiber system.

DE 10 2013 215 381 A1, for example, discloses a production method and a composite component, in particular for a wind turbine, having a plurality of at least two-component composite moldings, wherein a first component is formed from a shaping core material, and a second component is formed as part of a joining layer.

In DE 10 2009 044 834 B4, a textile semifinished product and a method for producing a preform for a fiber-reinforced composite component are described. In this case, a fiber reinforcing layer is formed, binder based on long-chain reactive resins that are solid at room temperature is applied as a web by spraying on the binder, the fiber reinforcing layer provided with the binder web is cold-formed, the formed fiber reinforcing layer provided with binder is heated, and is then cooled.

DE 10 2016 106 402 A1 relates to a component which is reinforced on the surface of the component by means of reinforcing fibers. Furthermore, the above publication relates to a method for reinforcing components with reinforcing fibers. In this case, the reinforcing fibers are impregnated with resin, a membrane which retains at least 99% by weight of the uncured and liquid resin at standard atmospheric pressure, or when the pressure is equal on both sides, is positioned between the component and the reinforcing fibers and, in addition, pressure is built up on the resin-impregnated reinforcing fibers, with the result that the resin penetrates through the membrane and bonds the reinforcing fibers to the component.

In principle, it is known that individual constituent parts of the fiber-reinforced composite blanks are joined together by a matrix material to produce a fiber-reinforced composite component. Moreover, approaches which envisage additional joining of the individual constituent parts are also known.

U.S. Pat. No. 8,709,584 B2, for example, discloses a composite panel, comprising: a core layer having a plurality of pins and a plurality of vertical pins, wherein the plurality of pins each extend within the core layer and beyond the core layer, and wherein the plurality of vertical pins each extend within the core layer without extending beyond the core layer; an inboard interlock layer having at least one ply mechanically interlocked with the plurality of pins; an inboard layer bonded to the inboard interlock layer, wherein the inboard layer has a first plurality of plies; an outboard interlock layer having at least one ply mechanically interlocked with the plurality of pins; and an outboard layer connected to the outboard interlock layer, wherein the outboard layer has a second plurality of plies of a first type and a second type, wherein the first type differs from the second type, wherein the second plurality of plies is greater than the first plurality of plies.

Connection of individual constituent parts of a fiber-reinforced composite blank in this way is usually carried out in technically complex production steps. Among known techniques, there is, for example, the practice of sewing material to be sewed, consisting, for example, of several carbon fiber mats, by means of a blind stitch sewing apparatus. A blind-stitch sewing apparatus of this kind is known from DE 100 40 807 A1.

Moreover, WO 98/29243 discloses an ultrasonic fastening system in which use is made of an ultrasonic transducer to insert a plurality of connecting elements supported by a compressible element into two components to be joined or into a single composite part.

The complex technical production steps for joining the components require specific manufacturing systems whose procurement is associated with high costs.

In addition, there is the fact that known manufacturing methods can only be used to insert connecting elements into components of geometrically simple configuration. As a result, the area of application of these fiber-reinforced composite components produced in this way is restricted to a considerable extent.

Among the challenges for production engineers in the sector of fiber-reinforced composite components there is, in particular, that of manufacturing fiber-reinforced composite components with different geometries.

In the priority application relating to the present application, the German Patent and Trademark Office identified the following prior art: DE 10 2016 121 554 A1.

### BRIEF SUMMARY

Embodiments described herein may offer a simple and low cost solution for producing a fiber-reinforced composite component or a fiber-reinforced composite blank. In particular, provided is a technique which brings about at least one optimized property with respect to demands arising from the effects of loads. In particular, one or more embodiments makes it possible to increase the shear stiffness and bending stiffness.

According to a first aspect of the present invention, provided is a fiber-reinforced composite blank for a fiber-reinforced composite component, in particular for a fiber-reinforced composite component of a wind turbine, comprising a layered construction with a form core consisting of or comprising a form core material, and a fiber layer adjoining the form core, said fiber layer consisting of or comprising a fiber layer material, and a plurality of reinforcing rods introduced into the form core and consisting of or comprising a reinforcing material, wherein the reinforcing material has a higher stiffness than the form core material, wherein the plurality of reinforcing rods is introduced into the form core at an angle to a form core plane, and wherein at least one reinforcing rod of the plurality of reinforcing rods is introduced into the form core at an angle to a direction orthogonal to the form core plane.

Fiber-reinforced composite blanks for fiber-reinforced composite components can comprise different constituent parts. It is generally the material properties and, under certain circumstances, also the geometric properties of the individual constituent parts that are critical for the properties of the fiber-reinforced composite components to be produced from the fiber-reinforced composite blanks. This makes it possible to combine properties of different constituent parts in a single fiber-reinforced composite component and, in particular, thereby to adjust the properties of the fiber-reinforced composite components, preferably through the choice of constituent parts, as a particular preference with specific reference to the area of use thereof.

Particularly in the case of large components that are preferentially subject to particular loads, e.g., in the case of rotor blades and other components of a wind turbine, high and extremely variable load effects occur, especially static and dynamic loads, which increase further as the size of a component of a wind turbine increases. Rotor blades of a wind turbine should generally be developed in such a way that they have a low weight while having a relatively high structural strength, as well as different degrees of hardness and a tensile strength matched to the effect of loads. In particular, rotor blades should be developed in such a way that they can withstand high static and dynamic loads, in particular also over many years. Owing to this challenge, particularly in respect of the load effects which occur, the rotor blades comprise or consist of, in particular, fiber-reinforced composite components.

The invention is based, in particular, on the insight that it is particularly advantageous to reinforce, in the thickness direction, fiber-reinforced composite blanks comprising at least two layers in order, in particular, to achieve an increase in the shear stiffness and bending stiffness of the fiber-reinforced composite component. Moreover, the intention is to improve transfer of shear forces between the layers. For this purpose, existing solutions envisage joining individual constituent parts of the fiber-reinforced composite blanks, in particular the at least two layers, by a plurality of unidirectional connecting elements extending through the individual constituent parts. In this case, the connecting elements are often introduced into the fiber-reinforced composite blank in the thickness direction over the entire extent of a surface—irrespective of load effects that actually occur. However, this is associated with increasing material costs and, in particular also, with an increasing weight of the fiber-reinforced composite blank and hence also of the fiber-reinforced composite component.

Existing solutions are designed to enable connecting elements to be introduced in a precise way into uncurved surfaces. However, fiber-reinforced composite components often also have highly curved regions, said regions being curved in a manner which is, in particular, determined by function. In this case, it is necessary to adapt the deformability and stiffness of the fiber-reinforced composite component and, in particular, of the highly curved regions to requirements arising from occurring load effects in accordance with an area of use of the fiber-reinforced composite component.

In the solution described here, a fiber-reinforced composite blank having a form core and a fiber layer in a layered arrangement is made available. Furthermore, reinforcing rods are introduced into the form core at an angle greater than 0°, preferably at an angle greater than 30°, to a form core plane. In this case, at least one reinforcing rod is introduced into the form core at an angle unequal to 90° to the form core plane. The reinforcing rods are thus introduced into the form core at different angles and, in this case, consist of or comprise a reinforcing material which has a higher stiffness than a form core material to enable them to be introduced into the form core without a change in length and shape in order to reinforce said core.

The form core described herein is preferably a three-dimensional element and/or preferably has a sheetlike extent in a form core plane, wherein the form core plane may be curved in at least one plane, e.g., cylindrically or in a dished shape, and/or preferably has a thickness in a direction orthogonal to the form core plane. The thickness is preferably many times less than an extent in a direction of the form core plane. The direction orthogonal to the form core plane can also be referred to as the thickness direction.

By means of this embodiment of the fiber-reinforced composite blank, required properties, e.g., in respect of strength, stiffness or elongation, can be optimized in order to achieve optimized behavior, under the effect of loads, of a fiber-reinforced composite component to be produced from the fiber-reinforced composite blank. In particular, the reinforcing rods make it possible to increase the modulus of elasticity of the form core in the thickness direction.

Furthermore, a higher bending stiffness and shear stiffness resulting from the embodiment of the fiber-reinforced composite blank ensures long-term stiffness and/or strength that counters the load effects. In particular, a shear modulus can be increased and a degree of shear modulus change can be influenced by way of a number and the angle of the reinforcing bars introduced, and thus adapted locally in an optimum manner.

It is furthermore advantageous that the specific introduction of the reinforcing rods, in particular with regard to a direction in which the reinforcing rods extend, defined by an angle to the form core plane and an angle to the direction orthogonal to the form core plane, makes it possible to provide fiber-reinforced composite blanks whose properties are adapted to local loads, thereby enabling optimum material utilization in terms of lightweight construction.

Moreover, it is possible, in particular, to use thinner form cores and/or fiber layers and/or to use less dense and lighter form core materials. An associated benefit is the possibility of reducing weight and costs.

The fiber-reinforced composite blank is produced substantially as a sandwich-type structure. In this case, constituent parts with different properties are assembled in layers. The constituent parts are a form core and at least one, preferably force-absorbing, fiber layer, which preferably adjoins the form core in a thickness direction.

A second fiber layer can preferably be provided, wherein the fiber layers can be held at a distance by the form core. In this case, the layered structure preferably comprises a top fiber layer and a bottom fiber layer, wherein the form core is arranged between the top fiber layer and the bottom fiber layer and preferably serves as a spacer. The form core can preferably transfer shear forces between the top fiber layer and the bottom fiber layer.

Where reference is made to the arrangement of the fiber layers in the layered structure, directional indications, such as “at the top” and “at the bottom”, preferably refer to the layered structure, preferably to the form core or the fiber layer, in an arrangement for producing the fiber-reinforced composite component or the fiber-reinforced composite blank with a layered arrangement from bottom to top in the sequence: optionally fiber layer—form core—optionally fiber layer.

The form core preferably has an extent, in particular a sheet-like extent, in the form core plane and a thickness orthogonal to the form core plane. In this case, the form core can preferably be used for shaping. In particular, the form core material can have a low density. In this context, structural form core materials are particularly preferred. Form core materials can preferably have a high mechanical stability and, in particular, a low weight.

In general, form core materials can have a very low strength and a final strength that is only achieved by being brought into contact, in particular impregnated, with a matrix material and curing of the matrix material. A form core material that has been brought into contact, in particular impregnated, with matrix material, particularly after curing, can preferably be designed to transfer occurring shear forces and, preferably, tensile forces and to support the fiber layer or, where applicable, the fiber layers.

The fiber layer material of the fiber layer comprises or consists of individual fibers, preferably a non-crimp fabric. The fiber layer material can preferably comprise fibers embedded in the matrix material and, in particular, can be a fiber-reinforced plastic.

In this case, the matrix material forms a matrix, which generally serves as a filler material and adhesive between the fibers. The fibers are thereby held in position in a fiber-reinforced composite material, and stresses are transferred and distributed between the fibers. Moreover, the matrix can serve as a means of protection from externally acting mechanical and/or chemical influences. As a preferred option, curable polymer material can be used as the matrix material.

In the solution described here, the form core, in particular the layered structure, is reinforced by means of the reinforcing rods. A reinforcing rod can be interpreted as a body which is, in particular, dimensionally stable, preferably rigid, and, in particular, substantially straight. In this case, the reinforcing rod has an extent in the longitudinal direction which is many times greater than an extent in the breadth direction and the cross-sectional area resulting therefrom.

The dimensional stability of the reinforcing rods is distinguished especially by the fact that the reinforcing rods are of substantially stable length and cross section. In order to ensure stability of length and cross section, the reinforcing material has a higher stiffness, in particular also a higher strength, than the form core material. As a particular preference, the reinforcing material may also have a higher stiffness and/or strength than the fiber layer. This makes it possible to introduce the reinforcing rods into the form core without changing the geometry. In particular, the reinforcing rods can be configured in such a way that they can be shot. In this case, the reinforcing material has a modulus of elasticity of at least 8 GPa. As a preferred option, the reinforcing rods can have a surface which is, in particular, smooth and can comprise or consist, in particular, of fiber-reinforced composite materials that are pultruded or pre-cured in some other way, e.g., GRP or CFRP, glass fibers, wood, titanium, aluminum or similar.

In comparison with the form core material, the reinforcing rods have a final strength upon introduction into the form core which preferably cannot be increased further by a substantial amount by bringing them into contact with the matrix material. In this context, a final strength can be interpreted to mean a strength which is suitable for reinforcing the fiber-reinforced composite blank, in particular at locations which are critical for buckling.

As a preferred option, the reinforcing rods can have an alignment in the form core which is, in particular, determined by function. As a preferred option, the reinforcing rods can be introduced into the form core at an angle of from 30° to less than 90°, preferably at an angle of from 40° to 80°, as a further preference of 45°, to the form core plane. The angle indicated here may be interpreted, in particular, to mean an angle of intersection which is defined as the smallest angle between the form core plane and the reinforcing rod.

A fiber-reinforced composite blank may be understood fundamentally to mean a semifinished product or a prefabricated raw material form. Accordingly, a fiber-reinforced composite blank is not a fully finished product and is processed to give a finished product, i.e., a fiber-reinforced composite component, only at a later stage. A fiber-reinforced composite blank comprises or consists of constituent parts which have preferably been arranged in an appropriate manner and given a basic geometric shape. Furthermore, a fiber-reinforced composite blank should preferably be interpreted to mean that, as precisely as possible, it has the shape and dimensions of the fiber-reinforced composite component to be produced in order to allow low cost manufacture of the fiber-reinforced composite component.

Where reference is made to properties of the fiber-reinforced composite blanks and/or fiber-reinforced composite components, requirements, loads, load effects or similar, these references relate to a finished product comprising or consisting of a fiber-reinforced composite component with a fiber-reinforced composite blank. The requirements, especially those relating to the properties, are a function of the loads and load effects acting on the finished product, for example, in particular those to be expected, and should be taken into account in the design and production of the fiber-reinforced composite blank and the fiber-reinforced composite component.

In a preferred development of the fiber-reinforced composite blank, it is envisaged that the reinforcing rods extend completely or partially through the form core. According to this embodiment, the properties of the fiber-reinforced composite blank can furthermore be adapted to defined requirements, particularly as regards an area of application of the fiber-reinforced composite component to be produced from the fiber-reinforced composite blank.

As a preferred option, the reinforcing rods can extend at least through part of the form core, preferably at least through up to ½ of the thickness of the form core or, as a further preference, up to ⅔ of the thickness or ¾ of the thickness or ⅘ of the thickness of the form core.

As a particularly preferred option, at least ¾ or ⅔ or ½ of the number of reinforcing rods can extend through part of the form core, preferably at least up to ½ of the thickness of the form core or, as a further preference, up to ⅔ of the thickness or ¾ of the thickness or ⅘ of the thickness of the form core. It is thereby possible to obtain a particularly advantageous embodiment of the fiber-reinforced composite blank in respect of properties adapted to local loads and in respect of material utilization in terms of lightweight construction.

As a preferred option, the reinforcing rods can extend through the form core and can have a region of attachment to the fiber layer, wherein the reinforcing rods at least touch the fiber layer in the region of attachment. As a particular preference, the reinforcing rods can extend through the region of attachment, wherein the reinforcing rods preferably extend through the form core and into the fiber layer, as a further preference through the fiber layer. It is thereby possible to attach the reinforcing rods to the fiber layer and to the form core during subsequent production of the fiber-reinforced composite component. It is thereby possible, in particular, to compensate for defects in a contact region between the form core and the fiber layer during the production of the fiber-reinforced composite component. Furthermore, it is thereby possible to ensure improved transfer of shear forces between the form core and the fiber layer.

As a further preference, it is envisaged that the reinforcing rods extend in the direction from a first end surface of the layered structure to a second end surface of the layered structure, wherein the first end surface lies opposite the second end surface. Here, this direction describes the thickness direction of the layered structure, wherein the thickness of the layered structure preferably comprises a sum of a thickness of the form core and a thickness of the fiber layer. An end surface of the layered structure can preferably be a surface of the form core or a surface of the fiber layer.

As a particular preference, the reinforcing rods can extend completely or partially through the fiber layer. It is thereby possible, in particular, to compensate for defects in a contact region between the form core and the fiber layer during the production of the fiber-reinforced composite component. Furthermore, it is thereby possible to ensure better transfer of shear forces between the form core and the fiber layer.

As a preferred option, the reinforcing rods can extend at least through part of the fiber layer, preferably at least up to ½ of the thickness of the fiber layer or, as a further preference, up to ⅔ of the thickness or ¾ of the thickness or ⅘ of the thickness of the fiber layer.

As a particular preference, at least ¾ or ⅔ or ½ of the number of reinforcing rods can extend through part of the fiber layer, preferably at least up to ½ of the thickness of the fiber layer or, as a further preference, up to ⅔ of the thickness or ¾ of the thickness or ⅘ of the thickness of the fiber layer.

In particular, there is a preference for the reinforcing rods to extend completely or partially through the form core and completely or partially through the fiber layer. It is thereby possible for the form core to be attached to the fiber layer and thus, in particular, for the fiber layer to be connected to the form core. It is thereby possible to further optimize reinforcement of the fiber-reinforced composite blank.

Provision is preferably made for the reinforcing rods to extend completely or partially through the form core, preferably in the direction from a first end surface of the layered structure to a second end surface of the layered structure, wherein the first end surface lies opposite the second end surface, and wherein the reinforcing rods preferably extend completely or partially through the fiber layer. By means of this embodiment, reinforcement can be accomplished at the locations that are critical for buckling, and the shear modulus can be locally adapted. In particular, shorter reinforcing rods, which extend partially through the form core, can be chosen if correspondingly lower loads are to be expected in respect of an area of application in order to save weight and costs.

According to this embodiment, the reinforcing rods can be arranged substantially in the form core. In this case, the reinforcing rods can displace the form core material that may come to rest in a particularly preferential way around the reinforcing rods.

A development of the fiber-reinforced composite blank which is a further preference is distinguished by the fact that the reinforcing rods have a maximum diameter of 5 mm, preferably a maximum diameter of 1 mm to 5 mm, as a further preference a maximum diameter of 2 mm to 5 mm.

In this context, a maximum diameter can be interpreted to mean the longest chord perpendicular to an axis of rotation of a reinforcing rod. By means of such an embodiment of the reinforcing rods, these can be introduced into the form core without significantly weakening the form core material, in particular without piercing the form core material.

In particular, it is preferred that reinforcing rods of different maximum diameters are introduced into the form core. The greatest possible adaptation of the stiffness and/or strength, in particular shear stiffness, of the fiber-reinforced composite component to be produced can thereby be achieved.

It is furthermore preferred that the reinforcing rods have a round and/or angular geometry. As a particular preference, the reinforcing rods can have a polygonal geometry, in particular a star-shaped geometry. It is thereby possible, in particular, to achieve better binding of the reinforcing rods to the form material in the fiber-reinforced composite component to be produced.

As a particular preference, the reinforcing rods have a length greater than 1 mm, preferably greater than 5 mm or 10 mm or 20 mm or 30 mm or 40 mm, as a further preference no more than 50 mm.

According to another preferred embodiment, the form core comprises a region that has more reinforcing rods and a region that has fewer reinforcing rods. As a preferred option, the regions in this case can comprise at least 100 rods per m² of surface of the form core. This makes it possible to introduce the reinforcing rods into the form core in a functionally distributed manner, i.e., in accordance with loads that are to be expected.

It is advantageous that the properties of the fiber-reinforced composite blanks can thereby be adapted locally and preferably individually.

As a particularly preferred option, a ratio of a sum of the volume of the reinforcing rods to a volume of the form core can be 1:10 or 1:20 or 1:50, as a further preference 1:100.

It is furthermore preferred that the form core material is selected from a material or a combination of materials, in particular polyethylene or polyvinylchloride or balsa wood or foam, in particular rigid foam. As a preferred option, the form core material can also comprise insulation or consist of insulation.

The preference here is that the form core material comprises polyethylene and/or polyvinylchloride and/or balsa wood and/or foam, in particular rigid foam, or consists of one of these materials or a combination of two or more of these materials. By virtue of the reinforcement of the form core by means of the reinforcing rods, it is possible, in particular, to use particularly light foam material, preferably with a low density. It is thereby possible, in particular, to make further weight and cost savings. In particular, there is a preference for the use of unshaped form core material.

According to another preferred variant embodiment, the reinforcing material comprises a matrix material and fibers embedded in the matrix material. As a particularly preferred option, the fibers can be embedded in substantially unidirectional alignment in the matrix material. As an alternative or additional measure, non-crimp fabrics and/or fiber bundles, in particular unidirectional fiber bundles, can be embedded in the matrix material. In this case, the matrix material is preferably cured. It is thereby possible to make available hardened, in particular stiffened, reinforcing rods.

In particular, it is preferred that the reinforcing material comprises a matrix material and fibers embedded in the matrix material, and wherein the matrix material is preferably cured. According to this variant embodiment, the fiber-reinforced composite blank, i.e., the semifinished product or raw material form, which is to be processed to form a fiber-reinforced composite blank, comprises cured reinforcing rods.

According to another preferred variant embodiment, it is envisaged that the reinforcing rods introduced into the form core each define a location of introduction on a surface of the form core, and the surface of the form core has a plurality of locations of introduction, and a plurality of locations of introduction each define a region of introduction, and a first region of introduction is spaced apart from a second region of introduction. In this case, it is possible, in particular, for regions of introduction to be spaced apart by at least 30 mm. As a preferred option, the locations of introduction of a region of introduction can, in particular, be spaced apart by at most 500 mm.

In this case, the particular preference is for regions of introduction of substantially annular design. In this case, the shape of a region of introduction is defined by the individual locations of introduction and an imaginary connection between the locations of introduction, in particular extending substantially through a central point. In the present case, the term “annular” can therefore be interpreted to mean not only configuration in the form of a circular ring but also a polygonal and/or multi-angled configuration.

As a preferred option in this case, the reinforcing rods can extend through the form core in such a way that they describe substantially the shape of a truncated cone in the form core. In this case, a maximum diameter of the region of introduction is extended over the thickness of the form core.

As an alternative, regions of introduction can essentially comprise locations of introduction arranged in a line. As a preferred option in this case, a maximum of 2, 3, 4, 6, 10 or 20 locations of introduction can define a region of introduction.

The reinforcing rods introduced into the form core can also define locations of introduction at an end surface of the layered structure, defined by a surface of the fiber layer, especially if the reinforcing rods are passed through the fiber layer when being introduced into the form core.

According to another preferred variant embodiment, it is envisaged that at least two reinforcing rods are introduced into the form core at different angles to the form core plane. As a preferred option, at least 3 or 4 or 5 reinforcing rods can be introduced into the form core at different angles to the form core plane. As a particularly preferred option, at least one quarter, preferably at least half, of the reinforcing rods per square meter can be introduced into the form core at different angles. It is thereby possible to ensure particularly reliable and optimized transfer of forces, preferably transfer of the shear forces.

Finally, according to another preferred variant embodiment, it is possible to provide for a maximum of two of three reinforcing rods to lie in one reinforcing plane in the form core. As a particular preference, the three reinforcing rods can lie in different reinforcing planes in the form core.

According to another aspect of the invention, provided is a fiber-reinforced composite component, in particular for a fiber-reinforced composite component of a wind turbine, comprising a fiber-reinforced composite blank and a cured matrix material, wherein the reinforcing rods are at least partially embedded, and the form core is embedded, into the cured matrix material and form a composite, wherein the cured matrix material binds the composite to the fiber layer. By means of the cured matrix material, it is possible, in particular, to harden the form core material. As a further preference, the fiber layer material can be hardened by the cured matrix material.

As a particularly preferred option, the cured matrix material can bind the reinforcing rods and/or the form core material to the fiber layer. In this case, it is particularly preferred if the matrix material makes contact with the surface of the reinforcing rods.

As a preferred option, the reinforcing rods can have substantially the same stiffness and/or substantially the same strength in the fiber-reinforced composite blank and in the fiber-reinforced composite component, i.e., after being brought into contact with matrix material and curing of the matrix material.

According to another aspect of the invention, provided is a rotor blade element for a rotor blade, in particular for a wind turbine, wherein the rotor blade element comprises at least one fiber-reinforced composite component.

According to another aspect of the invention, provided is a rotor blade, in particular for a wind turbine, comprising at least one rotor blade element.

According to another aspect of the invention, provided is a wind turbine comprising a tower, a nacelle and a rotor having a rotor hub and a plurality of rotor blades, wherein a rotor blade comprises at least one rotor blade element having at least one fiber-reinforced composite component, and/or the tower and/or the nacelle and/or the rotor hub comprise/comprises a fiber-reinforced composite component.

In particular, provided is a fiber-reinforced composite blank and/or a fiber-reinforced composite component for a rotor blade element for producing a rotor blade of a wind turbine and/or for a rotor blade and/or for a tower and/or a nacelle and/or a rotor hub of a wind turbine.

Moreover, provided is a fiber-reinforced composite blank and/or a fiber-reinforced composite component to produce a body component of motor vehicles and/or in shipbuilding or aircraft construction and/or in lightweight construction with composites and/or in components in the construction of buildings or roads and/or in other highly stressed structures.

In addition, provided is a method for producing a fiber-reinforced composite blank for the production of a fiber-reinforced composite component, in particular for a fiber-reinforced composite component of a wind turbine, comprising the following steps: making available a form core consisting of or comprising a form core material, making available a fiber layer consisting of or comprising a fiber layer material, forming a layered structure by layered arrangement of the form core and the fiber layer, making available a plurality of reinforcing rods consisting of or comprising a reinforcing material, wherein the reinforcing material has a higher stiffness than the form core material, positioning the plurality of reinforcing rods, wherein the plurality of reinforcing rods is positioned at an angle to a form core plane, and at least one reinforcing rod of the plurality of reinforcing rods is positioned at an angle to a direction orthogonal to the form core plane, introducing the plurality of reinforcing rods into the form core.

In this process, the fiber-reinforced composite blank is preferably produced in a half-shell sandwich construction. In particular, it is possible first of all to introduce the reinforcing rods into the form core and then to arrange the layers. As an alternative, it is possible first of all to arrange the layers and then to introduce the reinforcing rods into the form core. As a preferred option in this case, the introduction of the reinforcing rods into the form core can comprise passage through and/or introduction of the reinforcing rods into the fiber layer.

In particular, the reinforcing rods can be introduced into, preferably shot into, the form core in such a way that they extend completely or partially through the form core, preferably also completely or partially through the fiber layer. As a preferred option, the reinforcing rods can be introduced into the form core in such a way that they lie in the layered structure and, in particular, do not protrude from the layered structure.

According to a preferred embodiment, the reinforcing rods are introduced into the form core at a pressure of between 1 bar and 10 bar, preferably at a pressure of between 4 bar and 8 bar, as a further preference at a pressure of 7 bar.

As a particular preference, the reinforcing rods can be shot and/or hammered into the form core. Furthermore, the reinforcing rods can be introduced into the form core by means of a spring system, for example, preferably being stapled.

As a preferred option, the reinforcing rods can be shot into the form core at a pressure and/or a speed such that the reinforcing rods are introduced into the form core, with the result that the reinforcing rods as a whole lie within the layered structure. In particular, the reinforcing rods in this case are not shot through the entire layered structure. In particular, it is preferred that an introduced reinforcing rod does not protrude from the layered structure.

As a particular preference, reinforcing rods can be introduced individually into the form core. As a further preference, the reinforcing rods can be introduced in groups. In this case, the groups preferably comprise unidirectional and/or mutually spaced, in particular regularly uniformly spaced, reinforcing rods. As a further preference, a first group and a second group can be introduced simultaneously into the form core. As a preferred option, the first group and the second group can be introduced simultaneously or non-simultaneously into the form core. In particular, a plurality of groups of two or more reinforcing rods can be introduced simultaneously or non-simultaneously into the form core.

As a particular preference, the introduction of the reinforcing rods can comprise making available a reinforcing material, cutting a reinforcing rod from the reinforcing material, and introducing the reinforcing rod into the form core, wherein the reinforcing rod is preferably passed through the fiber layer.

As a preferred option, an introduced reinforcing rod can have an excess length which protrudes from the form core and/or from the fiber layer, wherein, in this case, the introduction of the reinforcing rods can be followed by the step of removing the excess length.

As a further preference, a fiber layer can be sealed after the passage of the reinforcing rods and optionally after the removal of excess lengths.

As a particular preference, the step of introducing the reinforcing elements into the form core can comprise the following repeated steps: making available a continuous reinforcing material, preferably wound onto a coil, cutting the continuous reinforcing material to a defined length, preferably using a hand tool, and introducing a cut reinforcing rod into the form core.

As a particular preference, the step of making available the continuous reinforcing material can comprise selecting a reinforcing material from a group of materials that has a higher stiffness than the form core material.

As a further preference, the step of making available the continuous reinforcing material can comprise selecting a reinforcing material and applying an adhesion promoter to a surface of the reinforcing material. It is thereby possible, in particular, to improve the adhesion properties of surfaces. Adhesion promoters can preferably be applied as a primer to a surface of the reinforcing material.

As a particular preference, the provision of the continuous reinforcing material can comprise selecting a reinforcing material from a group of materials comprising pultruded GRP and/or pultruded CFRP, particularly preferably thermosets, and/or wood and/or aluminum.

According to a preferred embodiment, the step of introducing the reinforcing elements into the form core can comprise passing the reinforcing elements through the fiber layer.

It is furthermore preferred that the reinforcing rods are shot into the form core, preferably using an air pistol. In this process, no specific production plant is required. The air pistol can be operated manually by one person, for example. The advantage of this is that the reinforcing rods can be introduced into the form core independently of a geometry of the fiber-reinforced composite blank. Moreover, the reinforcing rods can thereby be introduced individually into the form core, in particular in accordance with loads to be expected. This manufacturing step can be integrated as an intermediate step into the conventional sequence of manufacturing steps.

According to another aspect of the invention, provided is a method for producing a fiber-reinforced composite component, in particular for a wind turbine, preferably for a rotor blade of a wind turbine, comprising the following steps: producing a fiber-reinforced composite blank, bringing a matrix material into contact with the form core and the reinforcing rods introduced into the form core, wherein the reinforcing rods are embedded at least partially, and the form core is embedded, into the matrix material, and curing the matrix material, wherein the cured matrix material forms a composite and binds the composite to the fiber layer.

The fiber-reinforced composite components can be produced by resin infusion, preferably vacuum infusion. During this process, the constituent parts of the fiber-reinforced composite component are brought into contact with temperature-controlled and liquid matrix material. It is thereby possible to impregnate dry fibers of the constituent parts completely with the matrix material and to harden them by curing the matrix material. In the present case, the form core material comprises dry fibers. Moreover, the fiber layer can comprise dry fibers.

In the case of vacuum infusion, the fiber-reinforced composite blank is provided with a film that surrounds the fiber-reinforced composite blank, in particular in a substantially fluid-tight manner, in order to evacuate a space surrounded by the film, in particular by means of a vacuum pump. As a consequence, the fiber-reinforced composite blank, in particular the constituent parts of the fiber-reinforced composite blank comprising the dry fibers, preferably the form core material and/or the fiber layer material, no longer contains any air. In this process, the air pressure compresses the fiber layer and the form core and furthermore fixes them. In this method, the temperature-controlled, liquid matrix material can be sucked into the form core material and/or into the fiber layer material by the applied vacuum.

The curing of the matrix material can be accomplished, in particular, thermally and/or in dependence on a reaction.

Particularly by means of the sequence of manufacture, comprising first of all the production of the fiber-reinforced composite blank and subsequent impregnation of the fibers of the constituent parts with matrix material and curing the matrix material, it is possible for the locations of introduction formed by the introduction of the reinforcing rods into the form core to be filled and sealed by the matrix material. It is thereby possible, in particular, to prevent failure due to bearing stress.

In the cured state, the matrix material can, in particular, bind the form core to the fiber layer. As a preferred option, the matrix material can also bind the reinforcing rods to the form core and to the fiber layer. It is thereby possible to compensate for any defects in the region of contact between the form core and the fiber layer or between the form core and the matrix material. By means of such additional reinforcement of the fiber-reinforced composite component, it is also possible to compensate for weaknesses in the composite due to cracks that may arise during curing of the matrix material.

In particular, it is preferred that the constituent parts of the fiber-reinforced composite blank and, in particular, of the fiber-reinforced composite component are permanently joined to one another and/or fixed to one another and/or made to adhere to one another, thus giving rise to a three-dimensional component.

For further advantages, variant embodiments and embodiment details of these further aspects and their possible developments, attention is also drawn to the previously given description regarding the corresponding features and developments of the method.

### BRIEF DESCRIPTION OF THE SEVERAL VIEWS OF THE DRAWINGS

Preferred embodiment examples are explained by way of example with reference to the accompanying figures, of which:

FIG. 1 shows a schematic three-dimensional view of one illustrative embodiment of a wind turbine;

FIG. 2 shows a schematic three-dimensional illustration of a fiber-reinforced composite blank according to one embodiment example;

FIG. 3 shows a schematic three-dimensional illustration of a fiber-reinforced composite component according to one embodiment example;

FIG. 4 shows a schematic three-dimensional illustration of a fiber-reinforced composite blank according to one embodiment example;

FIG. 5 shows a schematic three-dimensional sectional illustration of a rotor blade according to one embodiment example;

FIG. 6 shows a schematic two-dimensional illustration of a rotor blade according to one embodiment example;

FIG. 7 shows illustrative method steps for the production of a fiber-reinforced composite blank according to one embodiment example; and

FIG. 8 shows illustrative method steps for the production of a fiber-reinforced composite component according to one embodiment example.

In the figures, identical or substantially functionally identical or similar elements are designated with the same reference signs.

### DETAILED DESCRIPTION

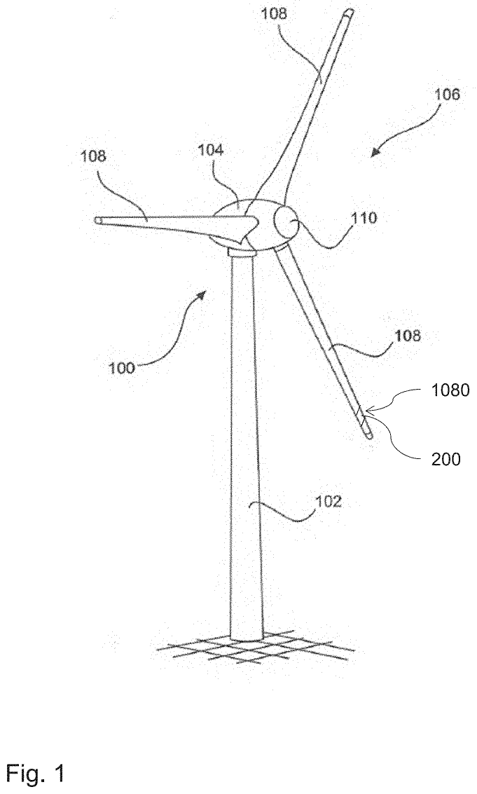

FIG. 1 shows a schematic three-dimensional view of one illustrative embodiment of a wind turbine. The wind turbine 100 has a tower 102 and a nacelle 104 on the tower 102. An aerodynamic rotor 106 with three rotor blades 108 and a spinner 110 is provided on the nacelle 104. The aerodynamic rotor 106 is set in rotation by the wind during operation of the wind turbine, and thus also rotates an electrodynamic rotor or runner of a generator, which is directly or indirectly coupled to the aerodynamic rotor 106. The electric generator is arranged in the nacelle 104 and generates electric energy. Fiber-reinforced composite components 200 can be used for different components of the wind turbine 100. According to this illustrative embodiment, a rotor blade 108 comprises a rotor blade element 1080 having at least one fiber-reinforced composite component 200 as described herein.

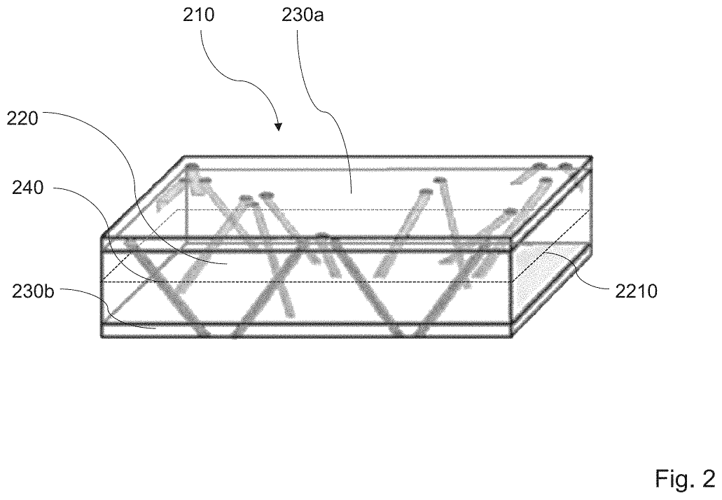

FIG. 2 shows a schematic, three-dimensional view of a fiber-reinforced composite blank 210. The fiber-reinforced composite blank 210 comprises a layered structure having a top fiber layer 230b, a form core 220 and a bottom fiber layer 230b. For better illustration, a form core material of the form core 220 and a fiber layer material of the top fiber layer 230a and of the bottom fiber layer 230b are illustrated as transparent in FIG. 2. In this case, the form core 220 spaces apart the top fiber layer 230a and the bottom fiber layer 230b. Moreover, the fiber-reinforced composite blank 210 comprises a plurality of reinforcing rods 240, which are introduced into the form core 220 at an angle greater than 0° to a form core plane 2210 and at an angle unequal to 90° to the form core plane 2210. According to this illustrative embodiment, the reinforcing rods 240 extend through the top fiber layer 230a, the form core 220 and the bottom fiber layer 230b. It is thereby possible to bind the fiber layers 230a, 230b to the form core 220 and, in particular, to improve transfer of shear forces between the fiber layers 230a, 230b and preferably between one of the fiber layers 20a, 230b and the form core 220.

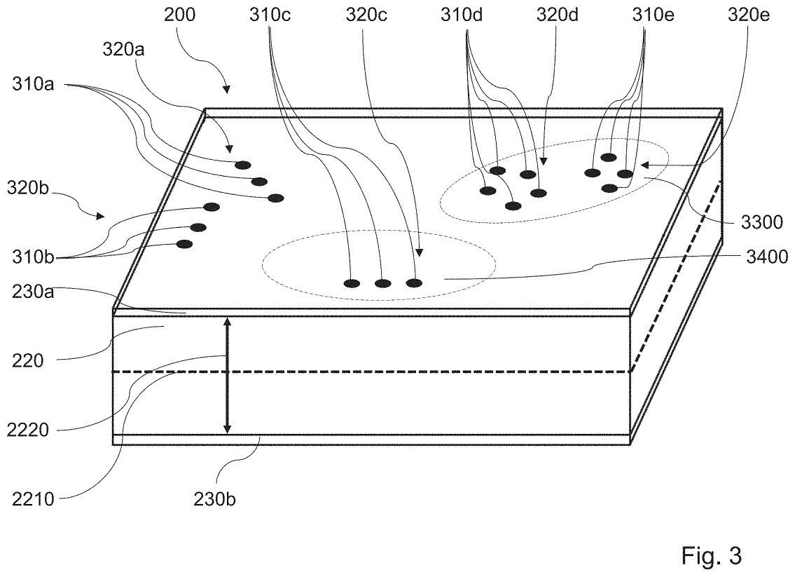

FIG. 3 shows a fiber-reinforced composite component 200 having a top fiber layer 230b, a form core 220, a bottom fiber layer 230b and a plurality of reinforcing rods in a schematic, three-dimensional view. In this case, the form core 220 has a sheet-like extent in a form core plane 2210, and an extent in the thickness direction defined by the thickness 2220, which extends orthogonally to the form core plane. In this case, the form core plane 2210 is generated substantially by a longitudinal axis and a transverse axis of the form core. In this case, the particular preference is that the longitudinal axis and the transverse axis intersect at a central point and/or a center of gravity of the fiber-reinforced composite component 200.

According to this embodiment, an end surface of the layered structure defined by a surface of the top fiber layer 320a has a plurality of locations of introduction 310a-310e. Here, the locations of introduction 310a-310e define a plurality of regions of introduction 320a-320e, which are spaced apart from one another. First regions of introduction 320a-320c are substantially in the form of a line and each comprise three locations of introduction 310a-310c. In this embodiment, second regions of introduction 320d, 320e are provided, these being defined by locations of introduction 310d, 320e. These regions of introduction 320d, 320e comprise four locations of introduction 310e or five locations of introduction 310d, which are arranged substantially in a ring shape. According to this embodiment example, the fiber-reinforced composite component 200 has regions that have more reinforcing rods 3300 and regions that have fewer reinforcing rods 3400.

The fiber-reinforced composite component 200 comprises a cured matrix material, which embeds the reinforcing rods into the form core 220 and into the fiber layers 230a, 230b. In this case, the matrix material binds a composite consisting of the form core 220 and reinforcing rods to the fiber layers 230a, 230b. In addition, the matrix material seals the locations of introduction 310a-310e. It is thereby possible, in particular, to prevent failure due to bearing stress.

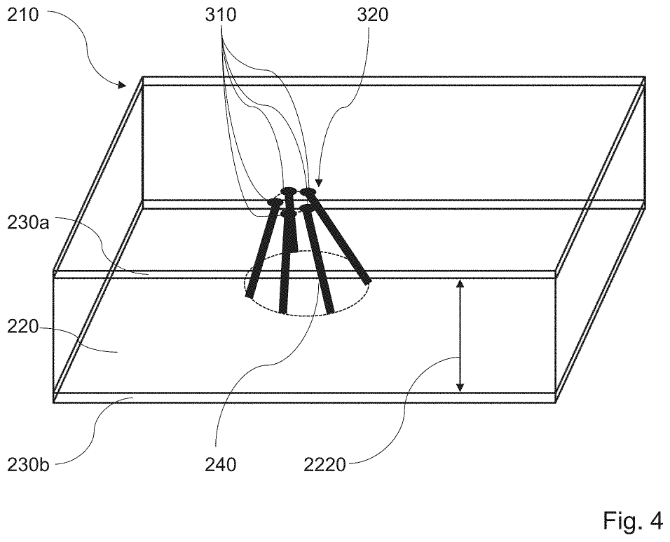

FIG. 4 shows a schematic illustration of a fiber-reinforced composite blank 210 in a three-dimensional view. The fiber-reinforced composite blank 210 has a top fiber layer 230a, a form core 220 and a bottom fiber layer 230b. For better illustration, a form core material of the form core 220 and a fiber layer material of the top fiber layer 230a and of the bottom fiber layer 230b are illustrated as transparent in FIG. 4. Here, the form core 220 acts as a spacer and spaces the top fiber layer 230a apart from the bottom fiber layer 230b. The upper end surface of the layered structure comprising the fiber layers 230a, 230b and the form core 220, which is defined by a surface of the top fiber layer 230a, has five locations of introduction 310, which define a substantially annular region of introduction 320. The locations of introduction 310 are spaced apart from one another in a substantially uniform manner. Starting from the locations of introduction, the reinforcing rods 240 extend through the top fiber layer 230a into the form core 220. In this case, a maximum diameter of the region of introduction 320 is extended over the thickness of the form core 220. Here, the reinforcing rods 240 essentially define a truncated cone.

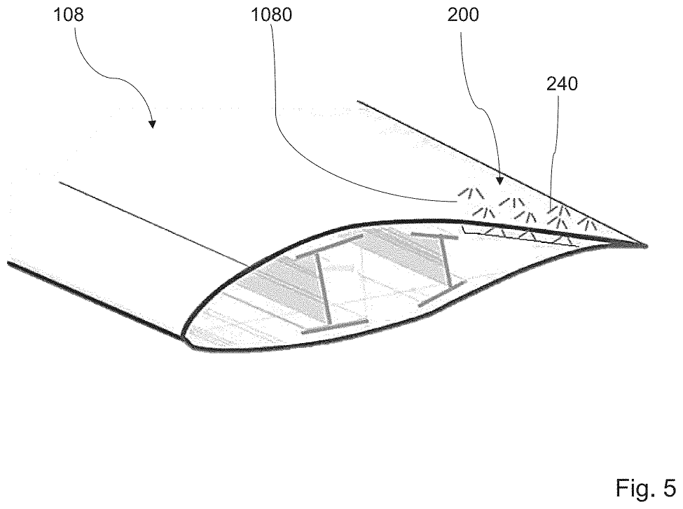

FIG. 5 shows a schematic three-dimensional view of a sectional illustration of a rotor blade 108. The rotor blade 108 has a rotor blade element 1080 comprising a fiber-reinforced composite component 200. Here, the fiber-reinforced composite component 200 has a plurality of reinforcing rods 240, which reinforce the fiber-reinforced composite component 200 and consequently also the rotor blade element 1080 or rotor blade 108.

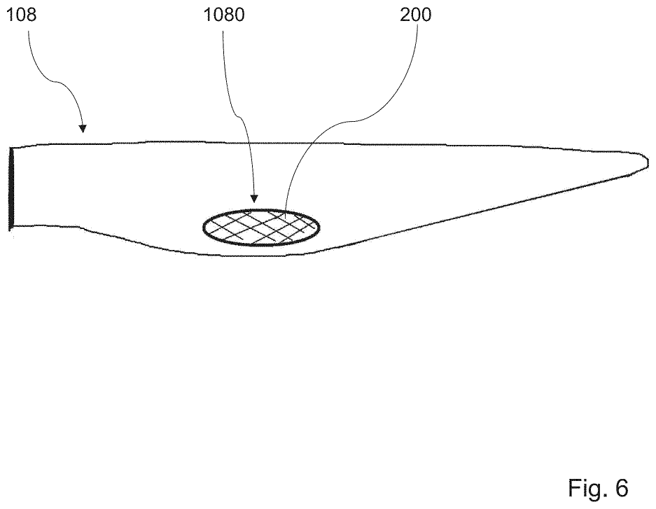

In corresponding fashion, FIG. 6 shows a rotor blade 108 in a schematic, two-dimensional view comprising a rotor blade element 1080, which comprises a fiber-reinforced composite component 200.

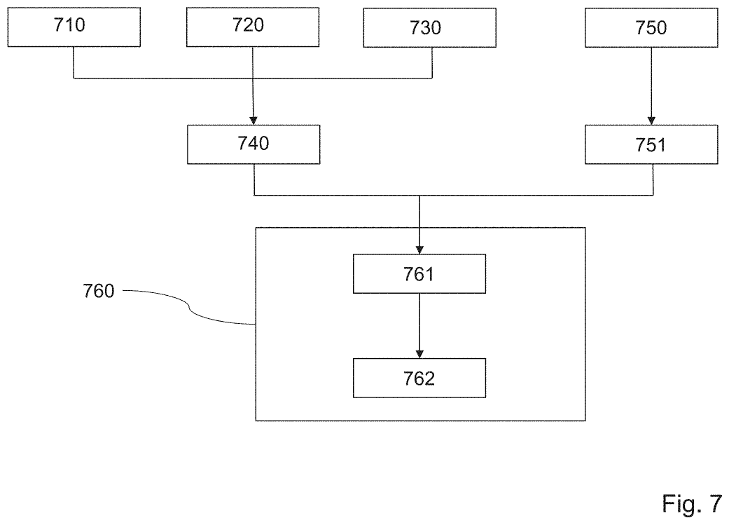

FIG. 7 shows a method for producing a fiber-reinforced composite blank for the production of a fiber-reinforced composite component. In this case, the individual constituent parts of the fiber-reinforced composite blank, comprising a form core 710 and two fiber layers 720, 730, are first of all made available. In a subsequent step 740, these constituent parts are arranged in layers in the sequence fiber layer—form core—fiber layer, with the result that a first fiber layer forms a bottom fiber layer, a second fiber layer forms a top fiber layer, and the fiber layers are spaced apart by the form core. Furthermore, a continuous reinforcing material, which is wound onto a coil, is made available 750 and cut 751 to a defined length using a hand tool. Continuous reinforcing material cut in this way defines a reinforcing rod and is introduced 760 into the layered structure comprising the form core and the two fiber layers. In this process, the reinforcing rod, in particular an air pistol for shooting in the reinforcing rod, is first of all positioned 761 at an angle of less than 90° and greater than 0° to the form core plane. Following this, the reinforcing rod is shot 762 through the top fiber layer into the form core by means of the air pistol. The steps of cutting 751 the continuous reinforcing material to a defined length, of positioning 761 the reinforcing rod cut in this way, and of shooting 762 the reinforcing rod through the top fiber layer into the form core are repeated multiple times. In this process, the continuous reinforcing material is cut to different lengths and shot into the layered structure at different angles.

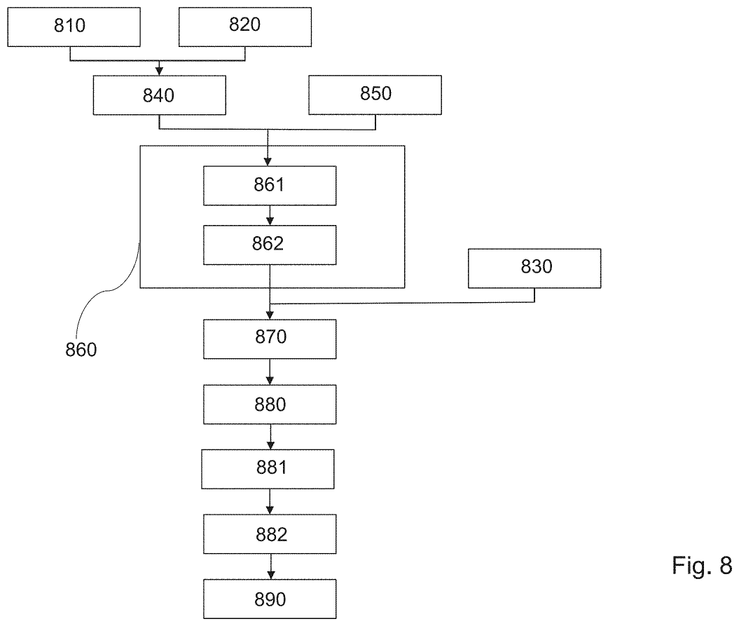

FIG. 8 shows individual method steps 810-890 of a method for producing a fiber-reinforced composite component. In this case, a fiber-reinforced composite blank 810-862 is first of all produced. During this process, a form core 810 and a fiber layer 820 are first of all made available. In a subsequent step, these constituent parts are arranged in layers in the sequence fiber layer 820—form core 810, with the result that the fiber layer forms a bottom fiber layer and the form core adjoins the fiber layer. In addition, reinforcing rods are made available 850. The reinforcing rods are introduced 860 individually into the form core by means of an air pistol. In this process, an air pistol with a reinforcing rod is first of all positioned 861 on the form core at an angle of less than 90° and greater than 0° to the form core plane. Following this, the reinforcing rod is shot 862 into the form core by means of the air pistol, with the result that it extends through the form core. Furthermore, a fiber layer is made available 830 and arranged 870 as a layer on the form core, with the result that it forms a top fiber layer and is spaced apart from the bottom fiber layer by the form core. In a subsequent step, the layered structure is provided 880 with a film, and the layered structure surrounded by the film is evacuated 881 by means of a vacuum pump. A temperature-controlled, liquid matrix material is thereby sucked 882 into the layered structure, i.e., into the form core and into the fiber layers. In this step, the fiber layer material of the fiber layers and the form core material of the form core are impregnated with the matrix material. Finally, the matrix material is cured 890. The cured matrix material embeds the reinforcing rods introduced into the form core and binds the individual constituent parts, i.e., the fiber layers, the form core and the reinforcing rods, to one another.

Fiber-reinforced composite components or fiber-reinforced composite blanks, comprising a fiber layer 230a, 230b, a form core 220, and reinforcing rods 240 introduced into the form core 220 have various advantages. In particular, a shear stiffness and a bending stiffness of the fiber-reinforced composite component 200 can be increased by introducing reinforcing rods 240 at different angles. Moreover, it is possible, in particular, to adapt a property of the fiber-reinforced composite component 200 to local loads in order thereby to permit optimum material utilization in terms of lightweight construction.

### LIST OF REFERENCE SIGNS

100 wind turbine

102 tower

104 nacelle

106 aerodynamic rotor

108 rotor blade

110 spinner

200 fiber-reinforced composite component

210 fiber-reinforced composite blank

220 form core

230a, 230b fiber layer; top fiber layer, bottom fiber layer

240 reinforcing rod

310, 310a-310e location of introduction

320, 320a-320e region of introduction

710 making available a form core

720 making available a fiber layer, bottom side

730 making available a fiber layer, top side

740 arranging in layers

750 making available a continuous reinforcing material

751 cutting the continuous reinforcing material to a defined length (reinforcing rod)

760 introducing the reinforcing rods

761 positioning the reinforcing rod or air pistol

762 shooting in the reinforcing rod

810 making available a form core

820 making available a fiber layer, bottom side

830 making available a fiber layer, top side

840 arrangement in layers

850 making available reinforcing rods

860 introducing the reinforcing rods

861 positioning the reinforcing rod

862 shooting in the reinforcing rod

870 arrangement in layers

880 providing the layered structure with a film

881 evacuating the layered structure

882 sucking the matrix material into the layered structure

890 curing the matrix material

1080 rotor blade element

2210 form core plane

2220 thickness

3300 region having more reinforcing rods

3400 region having fewer reinforcing rods

1. A fiber-reinforced composite blank for a fiber-reinforced composite component for a fiber-reinforced composite component of a wind turbine, comprising:
a layered construction comprising:
a form core comprising a form core material, and
a fiber layer adjoining the form core, the fiber layer comprising a fiber layer material, and
a plurality of reinforcing rods in the form core and comprising a reinforcing material, wherein the reinforcing material has a higher stiffness than the form core material,
wherein the plurality of reinforcing rods are in the form core at an angle relative to a form core plane, and
wherein at least one reinforcing rod of the plurality of reinforcing rods is in the form core at an angle relative to a direction orthogonal to the form core plane.

2. The fiber-reinforced composite blank as claimed in claim 1, wherein the plurality of reinforcing rods extend completely or partially through the form core.

3. The fiber-reinforced composite blank as claimed in claim 1, wherein the plurality of reinforcing rods have a maximum diameter of 5 mm (millimeters).

4. The fiber-reinforced composite blank as claimed in claim 1, wherein the form core material comprises at least one of polyethylene, polyvinylchloride, balsa wood, or foam.

5. The fiber-reinforced composite blank of claim 1, wherein the reinforcing material comprises a matrix material and a plurality of fibers embedded in the matrix material.

6. The fiber-reinforced composite blank as claimed in claim 1, wherein:
each of the plurality of reinforcing rods introduced into the form core define a location of introduction on a surface of the form core,
the surface of the form core has a plurality of locations of introduction, and wherein each of the plurality of locations of introduction define a region of introduction, and
a first region of introduction is spaced apart from a second region of introduction.

7. The fiber-reinforced composite blank as claimed in claim 1, wherein at least two reinforcing rods of the plurality of reinforcing rods are introduced into the form core at different angles to the form core plane.

8. The fiber-reinforced composite blank as claimed in claim 1, wherein a maximum of two of three reinforcing rods of the plurality of the reinforcing rods lie in one reinforcing plane in the form core.

9. A fiber-reinforced composite component, comprising the fiber-reinforced composite blank as claimed in claim 1, and a cured matrix material,
wherein at least portions of the plurality of reinforcing rods and the form core are embedded in the cured matrix material and form a composite, and
wherein the cured matrix material binds the composite to the fiber layer.

10. A rotor blade element for a rotor blade, wherein the rotor blade element comprises at least one fiber-reinforced composite component as claimed in claim 9.

11. A rotor blade for a wind turbine, comprising at least one rotor blade element as claimed in claim 10.

12. A wind turbine comprising:
a tower,
a nacelle, and
a rotor having a rotor hub and a plurality of rotor blades, wherein at least one rotor blade of the plurality of rotor blades is the rotor blade as claimed in claim 11.

13. A method comprising:
producing a fiber-reinforced composite blank for producing a fiber-reinforced composite component of a wind turbine, the producing comprising:
providing a form core comprising a form core material;
providing a fiber layer comprising a fiber layer material;
forming a layered structure by layered arrangement of the form core and the fiber layer;
providing a plurality of reinforcing rods comprising a reinforcing material, wherein the reinforcing material has a greater stiffness than the form core material;
positioning the plurality of reinforcing rods, wherein the plurality of reinforcing rods are positioned at an angle to a form core plane, and at least one reinforcing rod of the plurality of reinforcing rods is positioned at an angle to a direction orthogonal to the form core plane; and
introducing the plurality of reinforcing rods into the form core.

14. The method as claimed in claim 13, wherein the reinforcing rods are introduced into the form core at a pressure of between 1 bar and 10 bar.

15. A method comprising:
producing a fiber-reinforced composite component for a wind turbine for a rotor blade of a wind turbine, the producing comprising:
producing a fiber-reinforced composite blank as claimed in claim 1,
bringing a matrix material into contact with the form core and the plurality of reinforcing rods in the form core, wherein at least portions of the plurality of reinforcing rods and the form core are embedded in the matrix material, and
curing the matrix material, wherein the cured matrix material forms a composite and binds the composite to the fiber layer.

16. The method as claimed in claim 14, wherein the pressure is between 4 bar and 8 bar.

17. The fiber-reinforced composite blank as claimed in claim 4, wherein the foam is rigid foam or metal foam.

18. The fiber-reinforced composite blank as claimed in claim 3, wherein the plurality of reinforcing rods have a diameter between 2 mm and 5 mm.

19. The fiber-reinforced composite blank as claimed in claim 2, wherein the plurality of reinforcing rods extend completely or partially through the form core in a direction from a first end surface of the layered structure to a second end surface of the layered structure, wherein the first end surface lies opposite the second end surface.

20. The fiber-reinforced composite blank as claimed in claim 19, wherein the plurality of reinforcing rods extend completely or partially through the fiber layer.
